(19) United States
(12) Patent Application Publication
(10) Pub. No.: US 2011/0084925 A1
(43) Pub. Date: Apr. 14, 2011

(54) IMAGE FORMING APPARATUS TO DISPLAY ICONS REPRESENTING FUNCTIONS, AND ICON DISPLAY METHOD THEREOF

(75) Inventors: Hyun-su BAIK, Suwon-si (KR); Richard Sukyoon Woo, Seongnam-si (KR); Sang-hyup Lee, Suwon-si (KR)

(73) Assignee: Samsung Electronics Co., Ltd, Suwon-si (KR)

(21) Appl. No.: 12/903,283

(22) Filed: Oct. 13, 2010

(30) Foreign Application Priority Data
Oct. 13, 2009 (KR) 2009-97363

(51) Int. Cl. G06F 3/041; G06F 3/12

(52) U.S. Cl. 345/173; 358/1.15

(57) ABSTRACT

An icon display method of an image forming apparatus is provided which includes receiving an input regarding whether to change a display of an icon representing a function supported by the image forming apparatus, receiving a selection of at least one icon to be changed in display, from among a plurality of icons displayed on a graphical user interface (GUI), receiving an input of modification attributes for the at least one selected icon, storing the received modification attributes, and displaying the at least one selected icon on the GUI, and moving the at least one selected icon in the GUI according to the stored modification attributes. Therefore, it is possible to promote user conveniences.

### CROSS-REFERENCE TO RELATED APPLICATIONS

This application claims the benefit under 35 U.S.C. §119 (a) from Korean Patent Application No. 10-2009-0097363, filed on Oct. 13, 2009, in the Korean Intellectual Property Office, the disclosure of which is incorporated herein by reference in its entirety.

### BACKGROUND

1. Field of the Invention

The present general inventive concept relates to an image forming apparatus to display icons representing its functions, and more particularly, relates to an image forming apparatus to change the display status of icons, and an icon display method thereof.

2. Description of the Related Art

Various electronic apparatuses have been developed, and their use is widespread as evidenced by development of electronic technologies. These electronic apparatuses may include, for example, image forming apparatuses to form images on various media such as scanners, copiers, printers, facsimile machines or multifunction peripherals (MFPs).

These image forming apparatuses are connected to terminal personal computers (PCs) via network or local, to perform various functions such as scanning, printing, copying or faxing. Recent image forming apparatuses are configured to include display panels with predetermined size. These display panels may be implemented as touch screens.

Display panels may display function selection menus corresponding to various functions supported by image forming apparatuses. Accordingly, users may select desired function selection menus displayed on display panels, to control image forming apparatuses to operate in their desired direction.

However, in image forming apparatuses that have been widely used, the display status of these display panels remains unchanged. In other words, preset function selection menus are always displayed on preset areas of display panels.

Accordingly, users may feel bored of this configuration of display panels of image forming apparatuses. In particular, if a display panel is implemented as a touch screen, a user may touch only a preset area at all times, and accordingly the display panel may be locally damaged. Additionally, a fixed function selection menu is always displayed on a fixed area of the display panel, and thus problems such as a burning phenomenon may arise on the display panel.

### SUMMARY

The present general inventive concept provides an image forming apparatus to move the display position of icons representing functions of the image forming apparatus according to user settings, and an icon display method thereof.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a method of displaying icons on an image forming apparatus, the method including receiving an input to change a display of an icon representing a function supported by the image forming apparatus, receiving a selection of at least one icon to be changed in the display, from among a plurality of icons displayed on a graphical user interface (GUI), receiving an input of modification attributes for the at least one selected icon, storing the received modification attributes, and displaying the at least one selected icon on the GUI, and controlling the at least one selected icon to move in the GUI according to the stored modification attributes.

The receiving of the selection of the at least one icon may include receiving a selection of the at least one icon from an icon list of the plurality of icons displayed on the GUI or from a function list of functions supported by the image forming apparatus. The displaying of the at least one selected icon may include displaying the at least one selected icon distinctively from non-selected icons.

The icon list or the function list may be displayed on at least a portion of the GUI.

The at least one icon may be selected by a touch operation or a drag-and-drop operation.

The modification attributes for the at least one selected icon may include at least one of a movement range attribute, a size attribute, a shape attribute, a movement direction attribute, a motion type attribute, a movement speed attribute, a movement period attribute and a movement start time attribute with respect to the at least one selected icon moving in the GUI.

The modification attributes may be received individually or simultaneously for each of the at least one selected icon.

The movement start time attribute is used to set a time to initiate a movement of the icon when the image forming apparatus is maintained in a standby mode for the set time.

The method may further include logging on a user to the image forming apparatus. The modification attributes for the displayed icon may be displayed and stored adaptively for each logged-on user.

The method may further include storing a history log for the modification attributes stored for each user.

Example embodiments of the present general inventive concept may also be achieved by providing a method of displaying icons on an image forming apparatus, the method including displaying an icon representing a function supported by the image forming apparatus; and moving a display position of the icon on a screen according to preset modification attributes.

The screen may include an icon array display field to arrange icons representing functions supported by the image forming apparatus and to display the arranged icons, and an icon movement display field to display at least one icon selected from among the icons and to move a display position of the at least one selected icon according to the modification attributes.

Example embodiments of the present general inventive concept may also be achieved by providing an image forming apparatus including a graphical user interface (GUI) generator to generate a GUI to display an icon representing a function supported by the image forming apparatus, a user interface unit to display the GUI on a screen, a storage unit to store modification attributes for at least one icon selected from among a plurality of icons displayed on the GUI, after receiving an input of the modification attributes, and a controller to control the user interface unit so that the at least one selected icon moves according to the stored modification attributes.

The user interface unit may receive a selection of the at least one icon from an icon list or from a function list which is displayed on a portion of the GUI. The at least one selected icon may be displayed distinctively from non-selected icons.

The user interface unit may include a touch screen. The at least one icon may be displayed on the touch screen and may be selected by a touch operation or a drag-and-drop operation.

The modification attributes for the at least one selected icon may include at least one of a movement range attribute, a size attribute, a shape attribute, a movement direction attribute, a motion type attribute, a movement speed attribute, a movement period attribute and a movement start time attribute with respect to the at least one selected icon moving in the GUI.

The modification attributes may be received individually or simultaneously for each of the at least one selected icon.

The movement start time attribute may be used to set a time to initiate a movement of the icon when the image forming apparatus is maintained in a standby mode for the set time.

The controller may control the GUI generator so that the modification attributes may be displayed adaptively for each logged-on user. The storage unit may store the modification attributes set for each logged-on user.

The storage unit may store a history log for the modification attributes stored for each user.

The screen may include an icon array display field to arrange icons representing functions supported by the image forming apparatus and to display the arranged icons, and an icon movement display field to display at least one icon selected from among the icons and to move a display position of the at least one selected icon according to the modification attributes.

Example embodiments of the present general inventive concept may also provide a method of displaying icons on a display of an image forming apparatus, the method including receiving a selection of at least one icon displayed on the display of the image forming apparatus, receiving an input to change at least one display feature of an icon displayed on the display of the image forming apparatus, and displaying one or more icons on the image forming apparatus in according to the received input change of the at least one display feature.

The method may also include storing a history log in the image forming apparatus of at least one of the received selection of the at least one icon and the received input to change the at least one display feature.

The method may also include storing the received changes of the at least one display feature in the image forming apparatus.

The method may also include where the displaying the one or more icons according to the received input change includes changing the display position of the one or more icons according to the received input change.

Exemplary embodiments of the present general inventive concept may also provide an image forming apparatus, including a controller to generate a first image as an interface to include one or more icons to be displayed on a screen of a display, and to generate a second image to change a location of the one or more icons with respect to the screen.

The image forming apparatus may include where the controller receives a selection of at least one of the one or more icons to adjust a location of an icon or to perform an operation corresponding to the icon.

The image forming apparatus may include a unit to perform an operation to scan or print an image according to a received selection of an icon from the first image or the second image.

As described above, according to features and utilities of the present general inventive concept, it is possible to variously change the display position and the shape of icons representing functions capable of being supported by the image forming apparatus. Therefore, it is possible to prevent a display panel from being deteriorated, and to improve user's satisfactions.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1A illustrates a block diagram of an image forming apparatus according to exemplary embodiments of the present general inventive concept;

FIG. 1B illustrates the image forming apparatus of FIG. 1A communicatively coupled to a network and one or more computing devices according to exemplary embodiments of the present general inventive concept;

FIGS. 2 to 7 illustrate examples of display status of icons on an image forming apparatus according to exemplary embodiments of the present general inventive concept;

FIG. 8 is a flowchart illustrating an icon display method of an image forming apparatus according to exemplary embodiments of the present general inventive concept;

FIG. 9 is a flowchart illustrating in detail an icon display method of an image forming apparatus according to exemplary embodiments of the present general inventive concept; and

FIG. 10 is a flowchart illustrating an icon display method of an image forming apparatus according to exemplary embodiments of the present general inventive concept.

### DETAILED DESCRIPTION OF THE EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

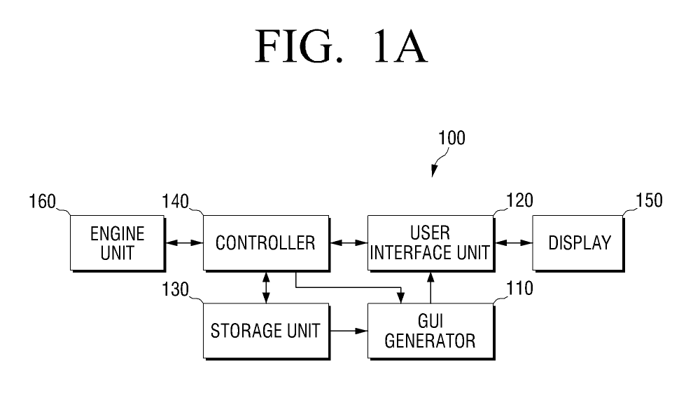

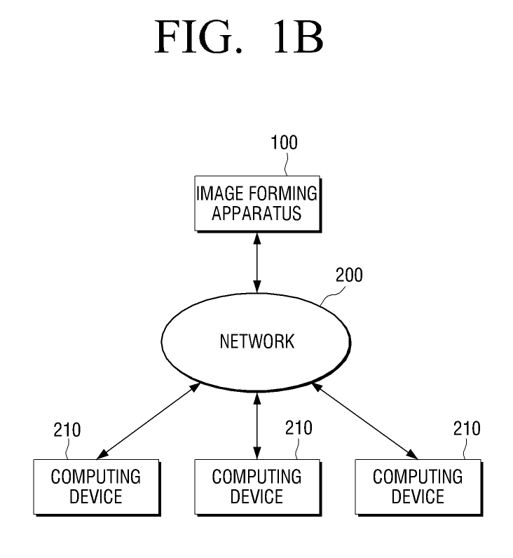

FIG. 1A illustrates a block diagram of an image forming apparatus according to exemplary embodiments of the present general inventive concept. The image forming apparatus 100 of FIG. 1A includes a graphical user interface (GUI) generator 110, a user interface unit 120, a storage unit 130, a controller 140, and a display 150. The image forming apparatus 100 may be a scanner, a copier, a facsimile machine, a printer, a multifunction peripheral (MFP), or other devices to carry out the exemplary embodiments of the present general inventive concept. The image forming apparatus 100 may include an engine unit 160 such as a scanning unit to perform a scanning operation to scan an object to generate image data or a printing unit to perform a printing operation to print an image on a print media according to, for example, the generated image data. Such an engine unit has been widely known in the related art, so illustration and description thereof is not provided herein.

The GUI generator 110 may generate a GUI to display an icon representing a function of the image forming apparatus 100. GUIs refer to technologies to support interfacing between apparatuses and users using graphical images. A user may manually touch desired GUI icons or may select desired GUI icons using various input means such as a mouse or a key, to control operations of the image forming apparatus 100. That is, the image forming apparatus 100 may receive input (e.g., a selection of an icon), and may control an operation according to the received input (e.g., print, copy, or scan a document, etc.).

The user interface unit 120 may display the GUI generated by the GUI generator 110 on a screen of the display 150. Alternatively, the user interface unit 120 may include a display panel (not illustrated). The display panel and/or display 150 may be a touch screen. The user interface unit 120 may further include a separate input apparatus (for example, a keypad).

A user may select at least one icon using the GUI displayed on the user interface unit 120. That is, the user interface unit 120 may receive input, such as a selection of at least one icon. Additionally, the user may set a modification attribute through the user interface unit 120, in order to apply the modification attribute to the selected icon. Herein, the modification attribute refers to an attribute used to determine how to modify icons on a screen of the display 150. In other words, the user may determine a display form of an icon and a method to move an icon, by setting the modification attribute. The user interface unit 120 may receive a modification attribute input, and may control the display of one or more icons on the screen of the display 150 according to the received modification attribute input.

The storage unit 130 may store a control program and one or more application programs to operate the image forming apparatus 100, data received from various external devices, data generated when one or more programs are executed, and/or information input received by the user interface unit 120. Although FIG. 1A illustrates the storage unit 130 as a single unit, the storage unit 130 may include a random-access memory (RAM), a read-only memory (ROM), or other memories, which may be separate units that may be communicatively coupled to one another. In particular, the storage unit 130 may store information of the icon selection received by the user interface unit 120 and information of the modification attribute to be applied to the selected icon. For example, a modification attribute may be received by the user interface unit 120, and may be applied to one or more icons selections that are received by the user interface unit 120.

The controller 140 may control the operation of the image forming apparatus 100. If the user desires to display the selected icon after setting the modification attribute, the controller 140 may control the GUI generator 110 and the user interface unit 120 so that the selected icon may be displayed on display 150 when moving according to the modification attribute stored in the storage unit 130.

The controller 140 may compute display coordinates of a GUI icon according to the modification attribute (e.g., a modification attribute received from the user interface unit 120 and/or stored in the storage unit 130). For example, if a user desires to move the GUI icon diagonally (e.g., a diagonal movement direction input is received by the user interface unit 120), the controller 140 may add or subtract a pixel value of about 1 or 2 (or any suitable value) to or from each coordinate value in an X, Y coordinate system. Accordingly, the display coordinates of the GUI icon may be computed according to a movement direction and a movement speed of the GUI icon. For example, the movement speed may be computed by the controller 140 according to the speed of an input movement received by the user interface unit 120.

The controller 140 may transmit a computed result to the GUI generator 110. The GUI generator 110 may control the display of an icon at a display position that is determined according to the computed result output from the controller 140. The user interface unit 120 may display the GUI generated by the GUI generator 110 on the display 150.

The controller 140 may compute display coordinates of icons on or more times according to the modification attribute, and accordingly, icons may be displayed (e.g., on display 150) while continuing to move. If the computing operation is set to be performed for one or more short intervals (e.g., a time interval less than or equal to a predetermined time threshold value), icons may be displayed while quickly moving (e.g., moving a rate determined according to the short interval that is less than or equal to the predetermined time threshold), or if the computing operation is set to be performed for every relatively long interval (e.g., a time interval that is greater than or equal to a predetermined time threshold), icons may be displayed while slowly moving (e.g., moving a rate determined according to the short interval that is less than or equal to the predetermined time threshold). If a value to be added or subtracted to or from each coordinate value is set to be small (e.g., a predetermined value that is less than or equal to a reference value), icons may be displayed as if they move smoothly, or if a value to be added or subtracted to or from each coordinate value is set to be large (e.g., a predetermined value that is less than or equal to a reference value), icons may be displayed as if they move while hopping.

The GUI generator 110 may generate one or more graphical effects to represent movement of one or more icons according to a received input selection by the user interface unit 120. For example, the GUI generator 110 may display a residual image caused by movement of icons on a screen of the display 150 for a predetermined period of time, and thus a visual effect may be enhanced.

FIG. 1B illustrates the image forming apparatus 100 (e.g., which is illustrated in detail in FIG. 1A), a network 200, and one or more computing devices 210. The image forming apparatus 100 and the one or more computing devices 210 may be communicatively coupled to one another via the network 200. The network 200 may be any suitable wired and/or wireless communication network. The one or more computing devices may be a computer, a cellphone, a smartphone, a personal digital assistant (PDA) device), or any suitable computation and communication device to carry out the exemplary embodiments of the present general inventive concept. One or more users may log-in to the image forming apparatus 100 via one or more of the computing devices 210 and via the network 200 to access and/or perform tasks (e.g., copying, printing, scanning, faxing, etc.) using the image forming apparatus 100, or may log-in to the network 200 via one or more of the computing devices 210.

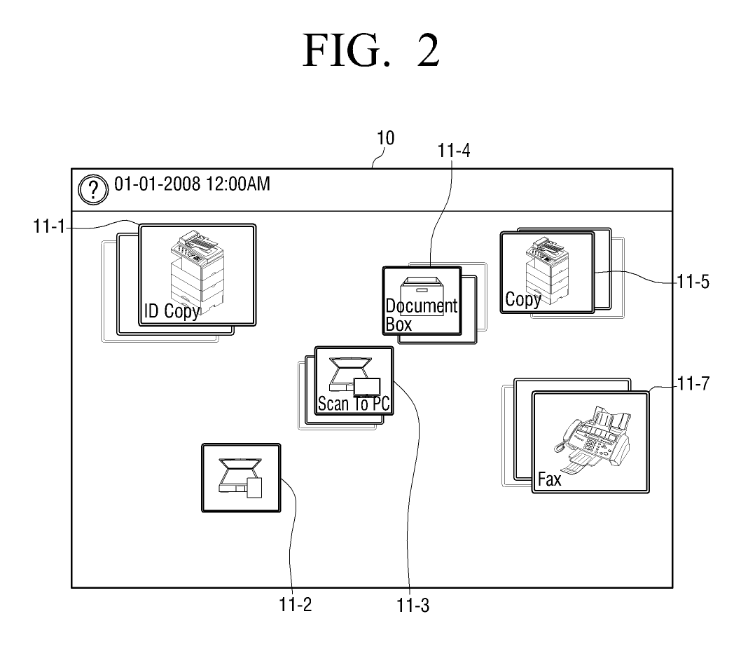

FIGS. 2 to 7 illustrate examples of display status of icons on an image forming apparatus according to exemplary embodiments of the present general inventive concept.

Referring to FIG. 2, a plurality of icons 11-1 to 11-n are displayed on a screen 10 of the image forming apparatus 100. Each of the plurality of icons 11-1 to 11-n appears on the screen 10 while moving in a predetermined direction, rather than being fixed on the screen 10.

The plurality of icons 11-1 to 11-n may be icons representing one or more of the functions supported by the image forming apparatus 100, or may be icons selected by a user among all icons, or may be icons set as default icons among all the icons. If a user logs on to the image forming apparatus 100, icons that have been selected in advance by the logged-on user, or icons accessible by only the logged-on user may be displayed. Alternatively, all the icons may be displayed or all of the predetermined default icons may be display, and only icons that are selected by the user or set as default icons among all the icons may be displayed while moving.

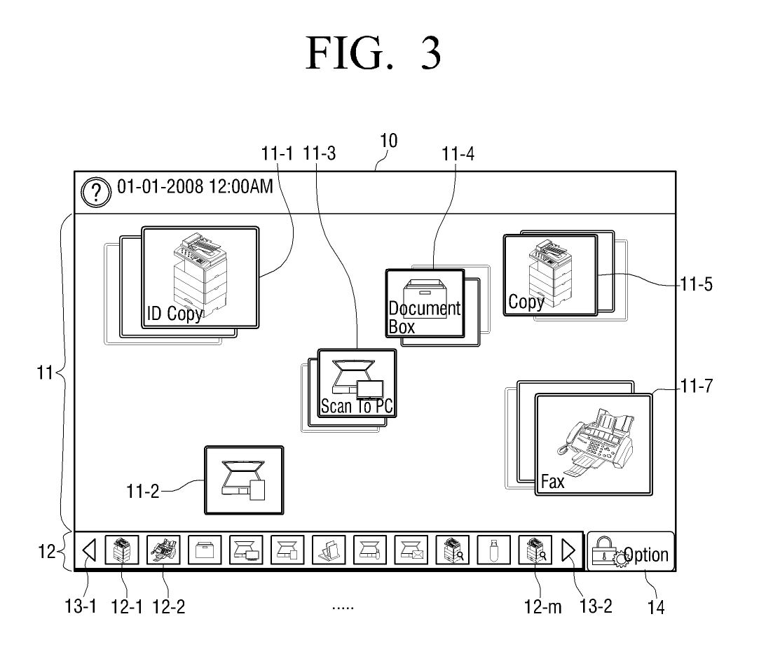

FIG. 3 illustrates an example screen configuration different from that illustrated in FIG. 2. Referring to FIG. 3, the screen 10 includes an icon movement display field 11 on which icons are displayed while moving, and an icon array display field 12 on which icons are arranged and displayed rather than moving. The screen 10 may include an “Option” menu 14 which is displayed, for example, on a side of the icon array display field 12. The option menu 14 may received selections of a modification attribute.

In FIG. 3, a plurality of icons 12-1 to 12-m representing one or more of the functions supported by the image forming apparatus 100 are arranged in a predetermined pattern or a selected pattern on the icon array display field 12 of the screen 10. If all the icons or a number greater than a predetermined number of icons cannot be displayed on a single screen due to a large number of icons, slide buttons 13-1 and 13-2 may be displayed on the screen 10, as illustrated in FIG. 3, so as to receive a selection (e.g., from a user) to slide the plurality of arranged icons 12-1 to 12-m horizontally from the selection of at least one of the slide buttons 13-1 and 13-2, to check icons.

A user may select an icon which he or she desires to move and display from the icon array display field 12, by a touch operation or a drag-and-drop operation. That is, the user interface unit 120 (illustrated in FIG. 1) may receive a selection and/or movement (including direction and input movement speed) of an icon. If the screen 10 is not a touch screen, the user may select a desired icon using a cursor and direction keys, or with any other suitable input unit that carries out the one or more exemplary embodiments of the present general inventive concept. The icon selected by the user from the icon array display field 12 may be moved to the icon movement display field 11, so that the display position of the icon may continue to be changed. For example, the user interface unit 120 may receive a selection and/or movement direction of an icon to the icon movement display field 11, and the controller 140 may control the movement of the display position of the selected icon in the icon movement display field 11.

The user may select a desired icon from a text-based function list of the image forming apparatus 100, instead of from the icon array display field 12. If the user selects the “Option” menu 14 of FIG. 3 or another predetermined key, the function list may be displayed on the screen 10, so that the user may select a predetermined function from the function list and may set an icon representing the selected function to appear while moving on the screen 10. As many icons can be arranged on the icon array display field 12, the size of the icons on the icon array display field 12 may be smaller than that of the icons on the icon movement display field 11.

According to exemplary embodiments of the present general inventive concept, the icon selected by the user from the icon array display field 12 may disappear from the icon array display field 12 or may remain on the icon array display field 12. If the selected icon is set to remain on the icon array display field 12, the selected icon may be displayed to be distinguished from non-selected icons. For example, the selected icon may be changed in color, or may be darker or may be made to flicker. The size of the selected icon may be increased or decreased from the non-selected icons. The selected icon may be distinguished from other icons in one or more ways in exemplary embodiment of the present general inventive concept.

The icon array display field 12 is displayed on the bottom edge of the screen 10 as illustrated in FIG. 3, but there is no limitation thereto. Accordingly, the icon array display field 12 may be displayed anywhere on the screen 10, and may be displayed as a band to enclose the icon movement display field 11. The display position of the “Option” menu 14 is not limited to one side of the icon array display field 12, and accordingly may be changed (e.g., the controller 140 may control the display position of the Option menu 14, according to received input from the user interface 120, predetermined settings stored in storage unit 130, etc.).

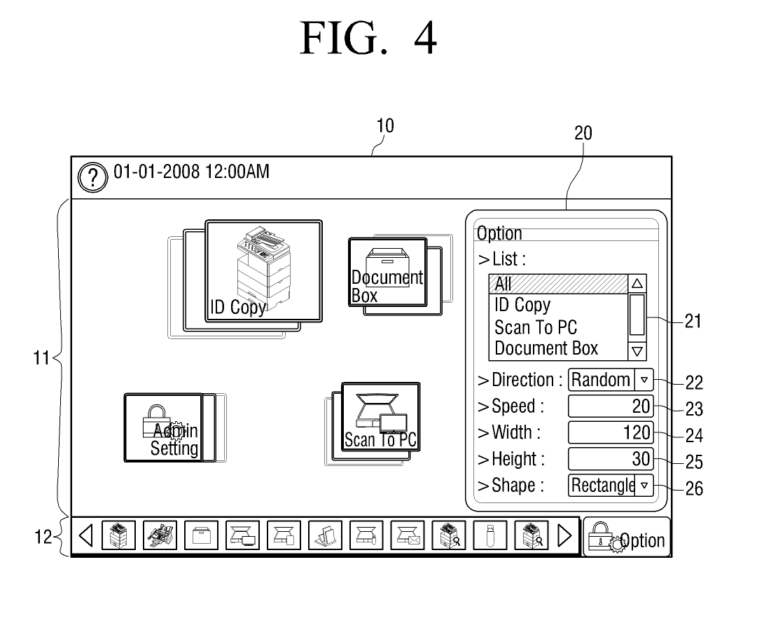

FIG. 4 exemplarily illustrates the screen 10 on which a field to set the modification attribute is displayed when a user selects the “Option” menu 14 from the screen 10 of FIG. 3.

Referring to FIG. 4, a modification attribute setting field 20 can be displayed on at least a portion of the screen 10. The modification attribute setting field 20 illustrated in FIG. 4 includes a list 21 of functions corresponding to icons to which the modification attributes are applied, a movement direction attribute 22, a movement speed attribute 23, a width attribute 24, a height attribute 25 and an icon shape attribute 26.

The list 21 can receive a selection of an icon to which attributes set through the modification attribute setting field 20 is to be applied, from among icons appearing on the icon movement display field 11. If a user selects “All” from the list 21, attributes to be set through the modification attribute setting field 20 may be applied to all the icons displayed on the icon movement display field 11.

The movement direction attribute 22 can receive a selection of the movement direction of the selected icon. The user may set the selected icon to move randomly or move horizontally, vertically or diagonally, using the movement direction attribute 22. The user may optionally set the movement speed, the width, the height and the icon shape through the movement speed attribute 23, the width attribute 24, the height attribute 25 and the icon shape attribute 26. In particular, the shape of icons may be changed to one or more shapes such as a triangle, a rectangle, a circle or a star, or any other suitable shape to carry out exemplary embodiments of the present general inventive concept.

Although not illustrated in FIG. 4, the modification attribute may include, for example, a movement range attribute, a motion type attribute, a movement period attribute, a movement start time attribute and a movement stop time attribute with respect to icons.

The movement range attribute for icons can be used to set a predetermined range on the icon movement display field 11 so that icons may move within the predetermined range only. For example, a user may divide the icon movement display field 11 into a plurality of fields, for example upper and lower, or left and right fields, and may set icons to move within each of the plurality of fields. The motion type attribute for icons can be used to determine how to move icons, for example whether to smoothly, gradually move icons, or to move icons by hopping. The movement period attribute can be used to determine a period for repeatedly switching between when icons are moving and when icons are staying. The movement start time attribute can be used to set a time to initiate movement of icons if the image forming apparatus is maintained in a standby mode, in which any operation is not performed, for the set time. The movement stop time attribute can be used to set a time to stop the movement of icons if the displayed icons move and a user does not input any command for the set time.

These modification attributes are merely examples, and, accordingly, one or more modification attributes may be provided in order to improve user convenience and aesthetic sensibility.

Information regarding the modification attributes set as described above may be stored in the storage unit 130 for one or more users. If a user logs on to an image forming apparatus (e.g., log-on to the image forming apparatus 100, log-on to the image forming apparatus via the computing device 210) or a network (e.g., log-on to the network 200 via one or more of the computing devices 210, etc.), the controller 140 may check the logged-on user, and may read information regarding icons that have been previously selected by the logged-on user and information regarding modification attributes that have been previously set by the logged-on user, from the storage unit 130. The controller 140 may move icons according to the read information from storage unit 130 regarding the modification attributes.

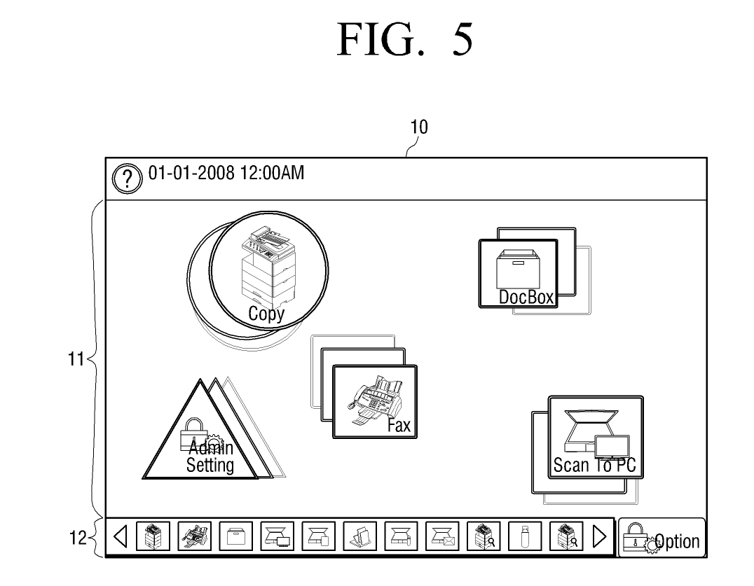

FIG. 5 exemplarily illustrates the configuration of the screen 10 changed and displayed when another new user logs on to an image forming apparatus (e.g., image forming apparatus 100) or a network (e.g., the network 200). Comparing the screen 10 of FIG. 4 to the screen 10 of FIG. 5, a “Fax” icon is additionally displayed on the icon movement display field 11 of FIG. 5, and a “Copy” icon and an “Admin Setting” icon are changed from the rectangular shape to a circular shape and a triangular shape, respectively. This change in shape of icons may be performed according to the modification attributes that have been set by the newly logged-on user. For example, the settings for these shapes of icons may be stored for a user in the storage unit 130, and may be displayed when the user logs in.

Information regarding a history for modification attributes changed by a user (e.g., a history log) may be stored in the storage unit 130. In response to a user request (e.g., input received via the user interface unit 120 and/or from the computing device 210), the controller 140 may control the display of the history log stored in the storage unit 130 through the user interface unit 120 (e.g. on the display 150).

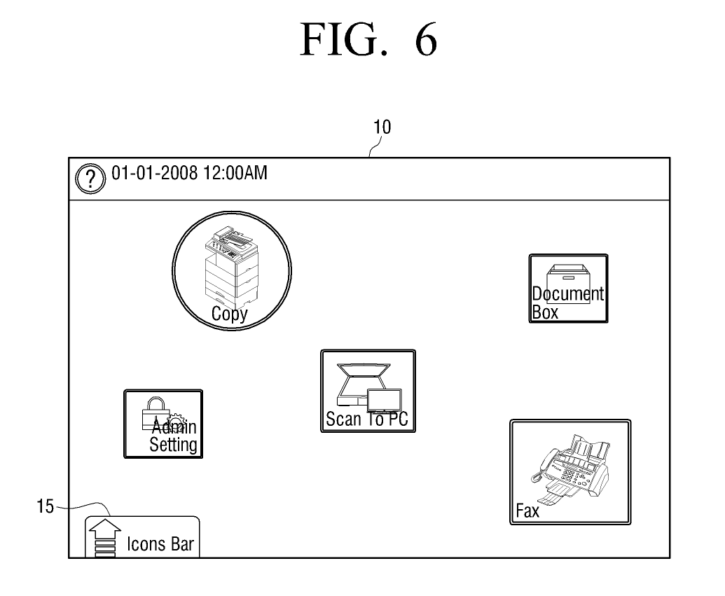

FIG. 6 exemplarily illustrates the configuration of the screen 10 displayed when there is no user input after a predetermined period of time. In FIG. 6, if a user does not enter any command for a predetermined period of time, icons on the icon movement display field 11 may stop their movement, the icon array display field 12 may disappear from the screen 10, and an “Icon Bar” menu 15 may appear on the screen 10. If the user selects the “Icon Bar” menu 15, the icon array display field 12 may again appear on the screen 10, and the icons on the icon movement display field 11 may start to move again.

When a user does not select any command for a predetermined period of time, one or more of the icons on the icon movement display field 11 may be deleted and may be displayed on the icon array display field 12. Alternatively, the controller 140 may deactivate one or more of the display status of icons according to predetermined rules stored in the storage unit 130, according to one or more received selections from the user interface 120, or by any other suitable method to carry out the exemplary embodiments of the present general inventive concept.

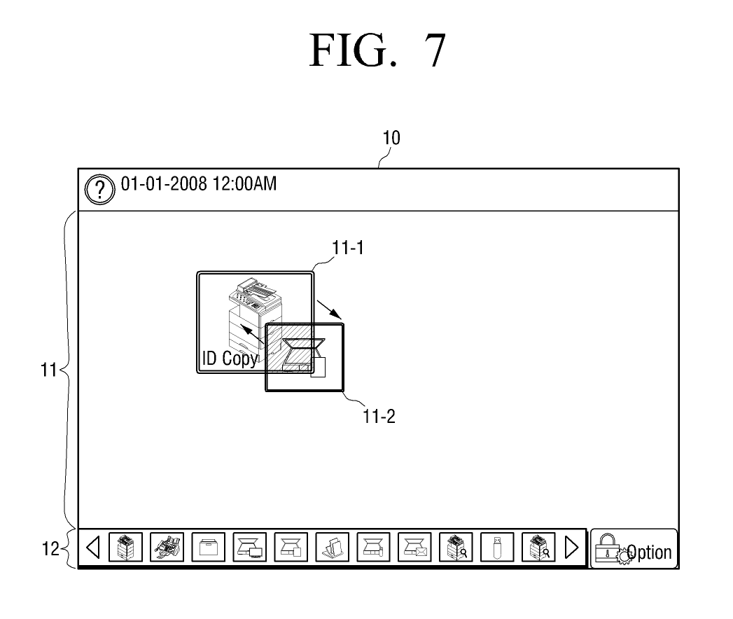

FIG. 7 exemplarily illustrates the screen 10 displayed when icons collide with each other when moving.

As illustrated in FIG. 7, if icons 11-1 and 11-2 collide with each other when moving on the icon movement display field 11, icons 11-1 and 11-2 may appear superimposed on each other. If icons 11-1 and 11-2 are set to move vertically, horizontally or diagonally, the movement direction of icons 11-1 and 11-2 may remain unchanged while icons 11-1 and 11-2 appear superimposed on each other.

Alternatively, if icons 11-1 and 11-2 collide with each other, icons 11-1 and 11-2 may bounce off each other, rather than icons 11-1 and 11-2 appearing superimposed on each other as illustrated in FIG. 7. In particular, if icons 11-1 and 11-2 are set to move in a random direction, the movement direction of icons 11-1 and 11-2 may be changed to the opposite direction after colliding. Alternatively, graphical effects representing the colliding status may be applied to the screen 10, and thus a user may feel more familiar and interesting.

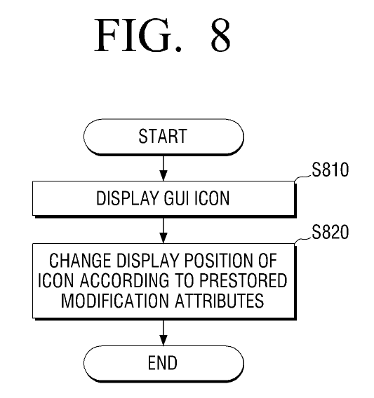

FIG. 8 is a flowchart illustrating an icon display method of an image forming apparatus according to exemplary embodiments of the present general inventive concept.

In FIG. 8, the image forming apparatus generates a GUI to display an icon representing a function supported by the image forming apparatus, and displays the generated GUI on a screen in operation S810.

If preset modification attributes exist (e.g., if preset modifications are stored in the storage unit 130 illustrated in FIG. 1), the image forming apparatus changes the display position of the icon according to the modification attribute in operation S820.

Operation S820 may be performed when a user selects an icon movement display function from among the one or more functions supported by the image forming apparatus. Additionally, a user may optionally select an icon which he or she desires to move and display, from among a plurality of icons provided by the image forming apparatus, and may determine how to move and display the selected icon.

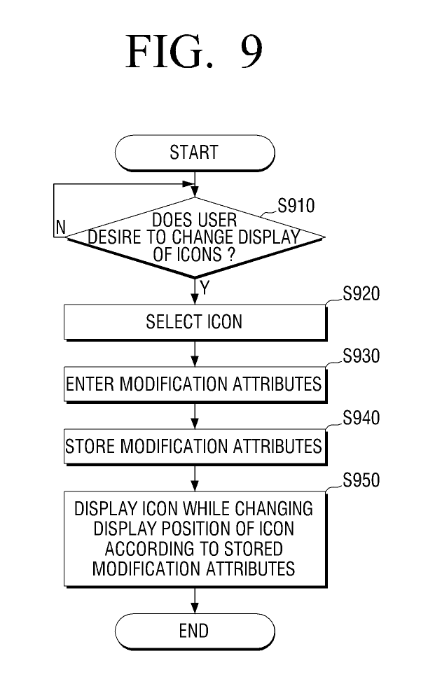

FIG. 9 is a flowchart illustrating an icon display method of an image forming apparatus according to exemplary embodiments of the present general inventive concept.

In FIG. 9, a user may enter a command to change display of icons in operation S910. For example, if a user selects the “Option” menu 14 from the screen 10 of FIG. 3, the modification attribute setting field 20 may be opened so that the user may change the display of icons, as illustrated in FIG. 4.

To change the display of icons, the user may select an icon which he or she desires to change and an icon which he or she desires to move and display in operation S920. For example, if the screen 10 is configured as illustrated in FIGS. 3 and 4, the user may manually select the icon which he or she desires to move and display, by the touch operation or the drag-and-drop operation. That is, the user interface unit 120 illustrated in FIG. 1 may receive a selection of an icon and/or a drag-and-drop input, and the controller 140 may display the screen 10 according to the received input. Alternatively, if a text-based function list is provided separately, the user may manually select a desired icon from the function list.

The user may select an icon corresponding to modification attributes which he or she desires to change, from the modification attribute setting field 20 illustrated in FIG. 4.

If the user enters modification attributes for the selected icon in operation S930, the image forming apparatus stores information regarding the modification attributes entered by the user in operation S940.

The image forming apparatus displays the selected icon while changing the display position of the selected icon according to the stored information in operation S950.

The configuration of the screen to display icons has been exemplarily described in detail with reference to FIGS. 2 to 7, so no further description thereof is provided herein.

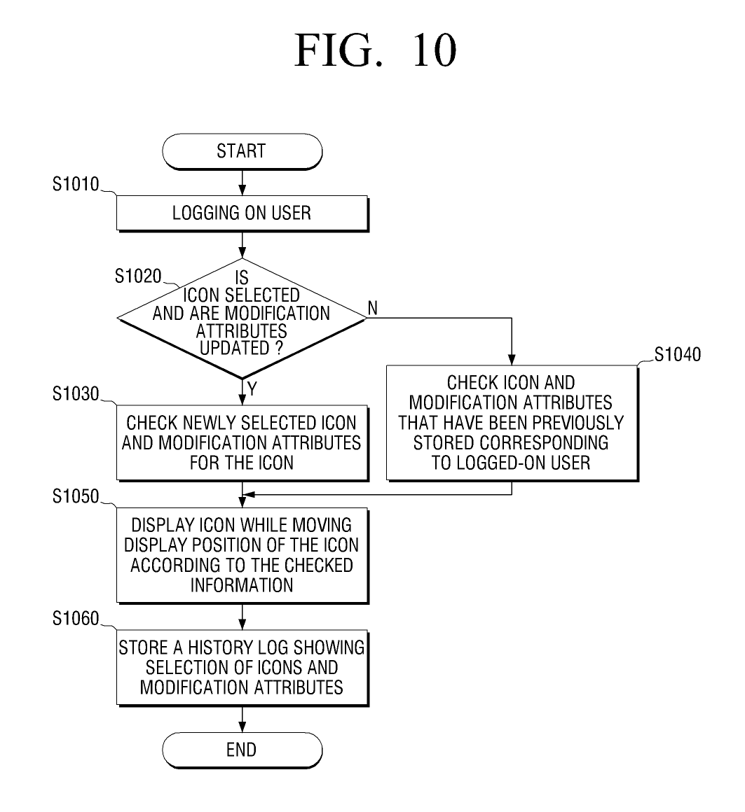

FIG. 10 is a flowchart illustrating an icon display method of an image forming apparatus according to exemplary embodiments of the present general inventive concept.

In FIG. 10, a user may log on to the image forming apparatus, or to a host PC, or to a network in operation S1010.

After logging on, the user may select at least one icon from among the icons displayed on a screen of the image forming apparatus, or may update modification attributes for the icons in operation S1020. Operation S1020 has been described above, so no further description thereof is provided herein.

If the user updates the modification attributes in operation S1020-Y, the image forming apparatus checks information regarding a newly selected icon and modification attributes for the newly selected icon in operation S1030, and displays the newly selected icon while moving the display position of the newly selected icon according to the checked information in operation S1050.

Alternatively, if the user does not update modification attributes in operation S1020-N, the image forming apparatus checks prestored information regarding an icon that has been previously selected by the user and modification attributes that have been previously set by the user in operation S1040. Accordingly, the image forming apparatus moves and displays the preselected icon on the screen while changing the display status of the preselected icon according to the preset modification attributes in operation S1050.

The image forming apparatus can store a history log, namely, a history to illustrating information on selection of icons and modification attributes changed by the user in operation S1060. The history log can be stored after the icon moves and appears as illustrated in FIG. 10, but may be stored, for example, after the icon is selected and modification attributes are set. The history log may be stored in the storage unit 130 of the image forming apparatus, or in a separate storage device, such as an external PC or a universal serial bus (USB) memory device. The history log may be transferred to a manager or another user by emailing or SMS messaging.

Features and utilities of the present general inventive concept are not necessarily limited to an image forming apparatus only, and accordingly may be applied to various electronic apparatuses having a display panel, for example, a mobile phone, a personal digital assistant (PDA), a gaming device, a navigator, an electronic frame or a television (TV).

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although several embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of displaying icons on an image forming apparatus, the method comprising:
receiving an input to change a display of an icon representing a function supported by the image forming apparatus;
receiving a selection of at least one icon to be changed in the display, from among a plurality of icons displayed on a graphical user interface (GUI);
receiving an input of modification attributes for the at least one selected icon;
storing the received modification attributes; and
displaying the at least one selected icon on the GUI, and controlling the at least one selected icon to move in the GUI according to the stored modification attributes.

2. The method of claim 1, wherein the receiving of the selection of the at least one icon comprises:
receiving a selection of the at least one icon from an icon list of the plurality of icons displayed on the GUI or from a function list of functions supported by the image forming apparatus,
wherein the displaying of the at least one selected icon comprises displaying the at least one selected icon distinctively from non-selected icons.

3. The method of claim 2, wherein the icon list or the function list is displayed on at least a portion of the GUI.

4. The method of claim 2, wherein the at least one icon is selected by a touch operation or a drag-and-drop operation.

5. The method of claim 1, wherein the modification attributes for the at least one selected icon comprise:
at least one of a movement range attribute, a size attribute, a shape attribute, a movement direction attribute, a motion type attribute, a movement speed attribute, a movement period attribute and a movement start time attribute with respect to the at least one selected icon moving in the GUI.

6. The method of claim 5, wherein the modification attributes are received individually or simultaneously for each of the at least one selected icon.

7. The method of claim 5, wherein the movement start time attribute is used to set a time to initiate a movement of the icon when the image forming apparatus is maintained in a standby mode for the set time.

8. The method of claim 1, further comprising:
logging on a user to the image forming apparatus,
wherein the modification attributes for the displayed icon are displayed and stored adaptively for each logged-on user.

9. The method of claim 8, further comprising:
storing a history log for the modification attributes stored for each user.

10. A method of displaying icons on an image forming apparatus, the method comprising:
displaying an icon representing a function supported by the image forming apparatus; and
moving a display position of the icon on a screen according to preset modification attributes.

11. The method of claim 10, wherein the screen comprises:
an icon array display field to arrange icons representing functions supported by the image forming apparatus and to display the arranged icons, and an icon movement display field to display at least one icon selected from among the icons and to move a display position of the at least one selected icon according to the modification attributes.

12. An image forming apparatus comprising:
a graphical user interface (GUI) generator to generate a GUI to display an icon representing a function supported by the image forming apparatus;
a user interface unit to display the GUI on a screen;
a storage unit to store modification attributes for at least one icon selected from among a plurality of icons displayed on the GUI, after receiving an input of the modification attributes; and
a controller to control the user interface unit so that the at least one selected icon moves according to the stored modification attributes.

13. The image forming apparatus of claim 12, wherein the user interface unit receives a selection of the at least one icon from an icon list or from a function list which is displayed on a portion of the GUI,
wherein the at least one selected icon is displayed distinctively from non-selected icons.

14. The image forming apparatus of claim 12, wherein the user interface unit comprises:
a touch screen,
wherein the at least one icon is displayed on the touch screen and is selected by a touch operation or a drag-and-drop operation.

15. The image forming apparatus of claim 12, wherein the modification attributes for the at least one selected icon comprise:
at least one of a movement range attribute, a size attribute, a shape attribute, a movement direction attribute, a motion type attribute, a movement speed attribute, a movement period attribute and a movement start time attribute with respect to the at least one selected icon moving in the GUI.

16. The image forming apparatus of claim 15, wherein the modification attributes are received individually or simultaneously for each of the at least one selected icon.

17. The image forming apparatus of claim 15, wherein the movement start time attribute is used to set a time to initiate a movement of the icon when the image forming apparatus is maintained in a standby mode for the set time.

18. The image forming apparatus of claim 12, wherein the controller controls the GUI generator so that the modification attributes are displayed adaptively for each logged-on user,
wherein the storage unit stores the modification attributes set for each logged-on user.

19. The image forming apparatus of claim 18, wherein the storage unit stores a history log for the modification attributes stored for each user.

20. The image forming apparatus of claim 12, wherein the screen comprises:
an icon array display field to arrange icons representing functions supported by the image forming apparatus and to display the arranged icons and
an icon movement display field to display at least one icon selected from among the icons and to move a display position of the at least one selected icon according to the modification attributes.

21. A method of displaying icons on a display of an image forming apparatus, the method comprising:
receiving a selection of at least one icon displayed on the display of the image forming apparatus;
receiving an input to change at least one display feature of an icon displayed on the display of the image forming apparatus; and
displaying one or more icons on the image forming apparatus in according to the received input change of the at least one display feature.
